(19) United States
(12) Patent Application Publication
(10) Pub. No.: US 2007/0185238 A1
(43) Pub. Date: Aug. 9, 2007

(54) Paint with mold inhibitor and insecticide

(75) Inventor: William Kish, Wadsworth, OH (US)

Correspondence Address: CHRISTOPHER JOHN RUDY, 209 HURON AVENUE, SUITE 8, PORT HURON, MI, 48060, US

(73) Assignee: No-Burn Investments, LLC, Wadsworth, OH (US)

(21) Appl. No.: 11/654,467

(22) Filed: Jan. 17, 2007

Related U.S. Application Data
(60) Provisional application No. 60/765,518, filed on Feb. 6, 2006.

(51) Int. Cl. C09D 5/14; B32B 27/00

(52) U.S. Cl. 523/122

(57) ABSTRACT

Paint composition has a mold inhibitor and an insecticide.

This claims benefits under 35 USC 119(e) of application No. US60/765,518 filed on Feb. 6, 2006 A.D., the specification of which is incorporated herein by reference.

### BACKGROUND TO THE INVENTION

1. Field and Purview

The present invention concerns a paint composition having a mold inhibitor and an insecticide, and methods for making and using it, as well as the composition in combination with a substrate. Preferably, the composition is a latex type paint.

2. Art and Problems

Various conventional paints are known. Among these are latex paints.

Such products may have a mold inhibitor added to provide “in the can” resistance to mold. In other cases, a mold inhibitor may purchased, for example, as a powder in a packet, and be stirred into the paint so as to provide mold inhibition for painted surfaces.

In the art of fire retardant paints, an excellent product is NO-BURN® PLUS fire retardant latex paint, available from NO-BURN, INC., Wadsworth, Ohio. It is both paint and fire retardant. Compare, U.S. patent application Pub. Nos. 2005/0138888 & 2005/0022888. A fire retardant paint may have a mold inhibitor. See, U.S. patent application Ser. No. 11/320,207. The specifications of those publications and that application are incorporated herein by reference.

Insect damage to building structures, including homes, notably, for example, from termites, especially in warmer climates, is also a problem of concern.

Certain paints may contain an insecticide. Note., U.S. Pat. Nos. 5,912,003; 5,931,994 & 6,881,248, the specifications of which are incorporated herein by reference.

An intumescent fire retardant paint may be provided with an insecticide, optionally with a mold inhibitor. See, U.S. patent application No. 60/761,646, the specification of which is incorporated herein by reference.

Various antifouling paints are available such as for marine use.

It would be desirable to improve upon the pertinent art.

### A FULL DISCLOSURE OF THE INVENTION

In address of the foregoing, in general, the present invention provides a paint composition having a mold inhibitor and an insecticide. It can be made by contacting paint-forming, mold inhibitor, and insecticide ingredients under conditions sufficient to form the composition, and it can be used by applying it to a substrate in an amount sufficient to kill and/or control mold and kill, control and/or repel a target invertebrate when the composition has dried on the substrate. It thus can be found in combination with the substrate itself or as a residue whereof.

The invention is useful in preservation and enhancement of buildings.

Significantly, by the invention, the art is improved in kind. Not only can paint protection and mold inhibition properties be provided a building structure but also can insect control properties, and this, notably, in one convenient composition. Fear of deterioration and weathering to a substrate, and damage or harassment otherwise caused by mold such as toxic black mold and insects such as termites, carpenter ants, bees, and so forth can be put to rest confidently.

Numerous further advantages attend the invention.

The invention can be further understood by the detail set forth below. This is, as with the foregoing, to be read in an illustrative and not necessarily limiting sense.

Hereby, a paint composition including both a mold inhibitor and an insecticide is provided. Any suitable paint, mold inhibitor, and insecticide ingredients may be employed, in any suitable amount.

As the foundational paint portion of the composition, included can be oil-based and latex paints. Water-based, latex paints are advantageously employed. Preferably, for purposes of the present invention disclosure, the paint does not contain or function as a fire retardant, thus being considered herein a “conventional” paint. Such foundational paint compositions, their formulations, and methods or process for making them are well known to any person skilled in the art. Moreover, many foundational paint compositions are available commercially.

Herein, the term, “mold inhibitor,” is an agent that can kill, control, or prevent growth of mold, mildew, or fungus, and so forth and the like flora, especially when formulated with a foundational paint, with insecticide. Preferably, however, use of the present composition, for example, on a solid material as the substrate, reduces growth of the flora of interest significantly, say, at least about 60%, at least about 85%, or at least about 99% or even at least about 99.9%, if it does not kill it outright, for a significant time, say, at least about thirty days, at least about six months, or at least about 360 days or a year, if not, in effect, indefinitely, as tested by appropriate test methodology. For example, the test method may be by ASTM D5590-94, Determination of Resistance of a Coating Material to Fungal Growth. Beneficially, control of toxic black mold (Stachybotrys chartarum) is provided hereby.

As the mold inhibitor, any suitable substance may be employed. Preferably, the mold inhibitor is compatible with the other components, and further is soluble or suspendable therewith. For instance, the mold inhibitor may be a quaternary organic ammonium halide, to include a quaternary alkyl ammonium halide, especially such a halide having at least one short chain and at least one medium chain alkyl group, for example, two of each, and an otherwise corresponding quaternary alkyl aromatic ammonium halide. The short chain alkyl group may be inclusive of, separately at each occurrence, a one- to an about five-carbon group, especially a one- to four-carbon group, for example, a methyl, ethyl, propyl, and so forth group. The medium chain alkyl group may be inclusive of, separately at each occurrence, an about six- to an about thirty-carbon group, especially a six- to an about twenty-carbon group, for example, hexyl, heptyl, octyl, nonyl, decyl, undecyl, dodecyl, a thirteen-, fourteen-, fifteen- or sixteen-, seventeen-, eighteen-, nineteen-, or twenty-carbon group, and so forth. Preferably, the short chain alkyl group is methyl and/or ethyl, especially methyl, and the medium chain alkyl group is an eight- to twelve-carbon group, to include a mixture thereof, especially decyl, which can be present as an n-alkyl group. The halide is advantageously a chloride. For example, the mold inhibitor employed may be didecyldimethylammonium chloride. An aromatic group, to include aryl, alkaryl and/or arylalkyl, for example, a benzyl and/or ethylbenzyl group may be present, for instance, in a quaternary organic to include a quaternary alkyl aromatic ammonium halide mold inhibitor, for example, alkyldimethylbenzylammonium chloride. The mold inhibitor may be a mixture containing more than one mold inhibitor compound.

As indicated above, any suitable amount of the mold inhibitor may be employed. The amount may be any that is sufficient to kill, control and/or repel a target mold, mildew, or fungus, and so forth and the like flora when the composition is applied to, and preferably dried on or in, a substrate. The mold inhibitor may be, independently at each occurrence, say, from 0.01% to 50% by weight of total composition, say, from 0.1% or 1% to 3%, 5% or 10% by weight of the total composition. Such values may be considered to be approximate or precise.

Herein, the term, “insecticide,” is an agent that can kill, control and/or repel a target invertebrate. The target invertebrate can be an insect per se, for example, a termite, a carpenter, sweet or grease eating ant, a bee, hornet or wasp, a roach, a fly, a mosquito, a cricket, an earwig, a silverfish, a tick, a flea, a beetle, and so forth; another arthropod such as a spider, a centipede, and so forth; and/or a worm or even a snail or slug, and so forth. Target invertebrates considered building pests, which could include the termites, ants, bees, hornets and wasps, roaches, crickets, earwigs, silverfish, fleas, beetles, and spiders, especially termites, desirably are killed, controlled and/or repelled hereby.

As indicated above, any suitable insecticide can be employed in the practice of the present invention, alone or in combination with another insecticide. Preferably, the insecticide is soluble or otherwise able to be carried with the remaining ingredients of the invention such as by dispersion, emulsion, and so forth, and preferably does not hinder any solubility or otherwise any capacity for being carried likewise of other ingredients of the composition of the invention, for example, the mold inhibitor. Preferably, too, the insecticide does not alter, at least significantly, other desirable physical characteristics of the composition that would otherwise exist without it such as pH, viscosity and so forth. Preferably also, the insecticide is stable in the composition before, i.e., “in the can,” and after application to the substrate, so as to provide for contact with the target invertebrate. Be that as it may, the insecticide may be or include inorganic, organic, natural and/or synthetic components, thus perhaps being or including Arsenic, Lead, Mercury, Thallium, or a compound of such, Phosphorus, an organophosphate, Sulfur, an organothio compound, a chlorinated organic compound, a pyrethroid, carbamide, carbimide, cyclopropanecarboxylate, a pyrethrin, and/or a piperonyl ether; examples may include, malathion, parathion, diazinon (0,0-diethyl-0,2-isopropyl-6-methyl(pyrinodine-4-yl)phosphorthioate), permethrin ((3-phenoxyphenyl)methyl(±)cis-trans-3-(2,2-dichloroethenyl)-2,2-dimethylcyclopropanecarboxylate) or CAS No. 52645-53-1), resmethrin, d-trans-allethrin, tetramethrin ((1-cyclohexene-1,2-dicarboximide)methyl-2,2-dimethyl-3-(2-methylpropenyl)cyclopropanecarboxylate), sumitlrin (3-phenoxybenzyl-(1RS,3RS; 1RS,3SR)-2,2-dimethyl-3-(2-methylprop-1-enyl)cyclopropanecarboxylate), piperonyl butoxide and butylcarbityl(6-propylpiperonyl) ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate, others, and so forth and the like.

As also indicated above, any suitable amount of the insecticide may be employed. The amount may be any that is sufficient to kill, control and/or repel a target invertebrate when the composition is applied to, and preferably dried on or in, a substrate. The insecticide may be, independently at each occurrence, say, from 0.01% to 50% by weight of total composition, say, from 0.1% or 1% to 3%, 5% or 10% by weight of the total composition. Such values may be considered to be approximate or precise.

Other ingredient(s) may be present.

The composition can be made by any suitable method. Ingredients may be in a form of a gas, liquid or solid. For instance, a liquid foundational paint formulation mixture may be contacted with a gaseous, liquid or powdered mold inhibitor and insecticide. Agitation as by stirring, sonic mixing, and so forth may render the composition more homogeneous or otherwise aid in suspending ingredient(s).

The composition can be applied to the substrate by any suitable method. Thus, for instance, after stirring, brushing, spraying, dipping and so forth may be employed. Preferably, the composition of the invention dries after application to the substrate.

As the substrate, any suitable substance may be employed. Preferably, however, the substrate is solid. Substrates can include those of metal, concrete, wood, fabric, paper, and so forth.

### CONCLUSION TO THE INVENTION

The present invention is thus provided. Various feature(s), part(s), step(s), subcombination(s) and/or combination(s) may be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

What is claimed is:

1. A paint composition comprising a foundational paint portion, a mold inhibitor, and an insecticide, wherein the foundational paint portion is conventional, i.e., is not fire retardant; the mold inhibitor is present in an amount sufficient to kill, control and/or repel a target mold, mildew, or fungus, and so forth and the like flora when the composition is applied to, and optionally dried on or in, a substrate; and the insecticide is present in an amount sufficient to kill, control and/or repel a target invertebrate when the composition is applied to, and optionally dried on or in, the substrate.

2. The composition of claim 1, which is in a form of a liquid.

3. The composition of claim 1, wherein the foundational paint portion is latex based.

4. The composition of claim 2, wherein the foundational paint portion is latex based.

5. The composition of claim 1, wherein the foundational paint portion is oil based.

6. The composition of claim 2, wherein the foundational paint portion is oil based.

7. The composition of claim 1, wherein the target mold, mildew, or fingus, and so forth and the like flora includes Stachybotrys chartarum; and the target invertebrate includes an arthropod.

8. The composition of claim 7, wherein the target invertebrate includes at least one arthropod considered to be a building pest.

9. The composition of claim 8, wherein the target invertebrate includes a termnite.

10. The composition of claim 1, wherein the mold inhibitor includes a quaternary organic ammonium halide; and the insecticide includes an organic compound.

11. The composition of claim 10, wherein the mold inhibitor includes a quaternary ammonium alkyl halide; and the insecticide includes an organothio compound, a chlorinated organic compound, a pyrethroid, a carbamide, a carbimide, a cyclopropanecarboxylate, a pyrethrin, and/or a piperonyl ether.

12. The composition of claim 1, wherein the mold inhibitor includes a quaternary alkyl ammonium halide, which includes at least one short chain alkyl group and at least one medium chain alkyl group, wherein the short chain alkyl group is, separately at each occurrence, a one- to an about five-carbon group, and the medium chain alkyl group is, separately at each occurrence, an about six- to an about thirty-carbon group; and the insecticide includes a substance selected from the group consisting of malathion, parathion, diazinon (0,0-diethyl-0,2-isopropyl-6-methyl(pyrinodine-4-yl)phosphorthioate), permethrin ((3-phenoxyphenyl)methyl(±)cis-trans-3-(2,2-dichloroethenyl)-2,2-dimethylcyclopropanecarboxylate) or CAS No. 52645-53-1), resmethrin, d-trans-allethrin, tetramethrin ((1-cyclohexene-1,2-dicarboximide)methyl-2,2-dimethyl-3-(2-methylpropenyl)cyclopropanecarboxylate), sumithrin (3-phenoxybenzyl-(1RS,3RS; 1RS,3SR)-2,2-dimethyl-3-(2-methylprop-1-enyl)cyclopropanecarboxylate), piperonyl butoxide and butylcarbityl(6-propylpiperonyl) ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate and a combination thereof.

13. The composition of claim 12, wherein the mold inhibitor is present in an amount about from 0.1% to 10% by weight of the total composition, and the insecticide is present in an amount about from 0.1% to 10% by weight of the total composition.

14. In combination, the composition of claim 1, and the substrate on or in which the composition resides.

15. The combination of claim 14, wherein the composition is dried.
